(19) United States
(12) Patent Application Publication
(10) Pub. No.: US 2004/0243499 A1
(43) Pub. Date: Dec. 2, 2004

(54) Method and system for providing enhanced stable value

(76) Inventors: Douglas F. Bateson, New York, NY (US); Michael H. Monforth, Ridgewood, NJ (US); Patrick J. Hellen, South Orange, NJ (US); Scott A. Kay, Brooklyn, NY (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/829,026

(22) Filed: Apr. 20, 2004

Related U.S. Application Data
(60) Provisional application No. 60/464,543, filed on Apr. 22, 2003.

(51) Int. Cl. G06F 17/60

(52) U.S. Cl. 705/35; 705/4

(57) ABSTRACT

Aspects of a stable value product and a total return swap are combined to provide for coordinated investment. A rate based on LIBOR on the amount of the swap plus a percentage is paid in exchange for the total returns on a specified index and a fee is paid in exchange for the stable value. Balances and amounts due are periodically computed and payments of a net difference are made.

This application claims priority to U.S. Provisional Patent Application Serial No. 60/464,543, filed Apr. 22, 2003, and entitled METHOD AND SYSTEM FOR PROVIDING ENHANCED STABLE VALUE, the disclosure of which is incorporated herein by reference.

### BACKGROUND

1. Field of the Invention

The invention relates to the field of financial instruments, risk management and stabilizing investment returns, and more particularly to a combination of total return swap agreements with stable value contracts.

2. Description of the Related Art

Stable value products are known in certain financial areas. Derivative instruments, such as total return swaps are also known in certain financial areas.

What is needed is a system and method for combining aspects of these different products and instruments to take advantages of particular characteristics of each product or instrument.

The preceding description is not to be construed as an admission that any of the description is prior art relative to the present invention.

### SUMMARY OF THE INVENTION

In one aspect, the invention provides methods and systems for coordinated investment comprising: providing a stabilized return on holdings of fluctuating return assets that are held by an insurance carrier account; providing a second return, where the second return is substantially based on value of an established index and value of a notional investment; and adjusting the holdings of fluctuating return assets in response to a change in the second return.

In another aspect, the invention provides methods and systems for a stable value provider to provide coordinated investment, comprising: providing a stabilized return to an insurance carrier separate account on holdings of fluctuating return assets that are held by the insurance carrier separate account; providing a total return to the insurance carrier separate account, where the total return is based on value of an established index and value of a notional investment; and periodically adjusting the stabilized return or the total return.

In another aspect, the invention provides methods and systems for coordinated investment by an insurance company account, comprising: receiving a stabilized return on holdings of fluctuating return assets that are held by the insurance carrier account; receiving a second return, where the second return is substantially based on value of an established index and value of a notional investment; and adjusting the holdings of fluctuating return assets in response to a change in the second return.

In another aspect, the invention provides methods and systems for coordinated investment by an insurance company separate account comprising: receiving a stabilized return on holdings of fluctuating return assets that are held by the separate account; receiving a total return that is based on the value of an established index and value of a notional investment; and periodically adjusting the stabilized return or the total return.

The various aspects, may further comprise receiving LIBOR plus or minus a percentage wherein the percentage is a spread, and receiving LIBOR plus or minus a percentage is linked to providing the second return. The various aspects may further comprise receiving a fee linked to providing the stabilized return. The various aspects may further comprise adjusting the holdings of fluctuating return assets in response to a change in the notional investment.

The insurance carrier account may be a separate account. The second return may be a total return swap based on the established index, and based on the notional investment. Adjusting the holdings of fluctuating return assets may occur on a periodic basis, such as every month, or every quarter. A stable value provider may provide the stabilized return. A stable value provider may provide the second return. An insurance carrier holding the insurance carrier account may adjust the holdings of fluctuating return assets. Periodically adjusting the stabilized return may occur in response to a change in the holdings of the fluctuating return assets that are held by the insurance carrier separate account. Periodically adjusting the total return may occur in response to a change in the notional investment. Periodically adjusting the stabilized return may occur in response to a change in the notional investment.

The foregoing specific aspects of the invention are illustrative of those which can be achieved by the present invention and are not intended to be exhaustive or limiting of the possible advantages that can be realized. Thus, the aspects of this invention will be apparent from the description herein or can be learned from practicing the invention, both as embodied herein or as modified in view of any variations which may be apparent to those skilled in the art. Accordingly the present invention resides in the novel parts, constructions, arrangements, combinations and improvements herein shown and described.

### BRIEF DESCRIPTION OF THE DRAWINGS

The foregoing features and other aspects of the invention are explained in the following description taken in conjunction with the accompanying figures wherein:

FIG. 1 illustrates an embodiment of company owned life insurance;

FIG. 2 illustrates an embodiment of stable value provided with company owned life insurance; and

FIG. 3 illustrates an embodiment of enhanced stable value provided with company owned life insurance.

It is understood that the drawings are for illustration only and are not limiting.

### DETAILED DESCRIPTION OF THE DRAWINGS

In one embodiment, the invention provides an investment strategy that can be offered to clients who seek to hedge and/or fund employee deferred compensation liabilities and capture extra value as part of that hedge. Although not specifically illustrated, the methods and steps of the invention, which are described in detail below, are generally accomplished or performed on, by or with support from computer systems, with memory, processors, fixed and removable code storage media, input/output devices, printers, and network adaptors providing network communication with other similar computer systems.

To accomplish these objectives, the invention uses a combination of Corporate Owned Life Insurance (COLI) policies, which companies often use to hedge and/or provide informal funding for their deferred compensation liabilities; a Stable Value Contract that dampens the volatile return from certain of the COLI assets; and a total return swap, or similar derivative strategies.

Corporate Owned Life Insurance (COLI)

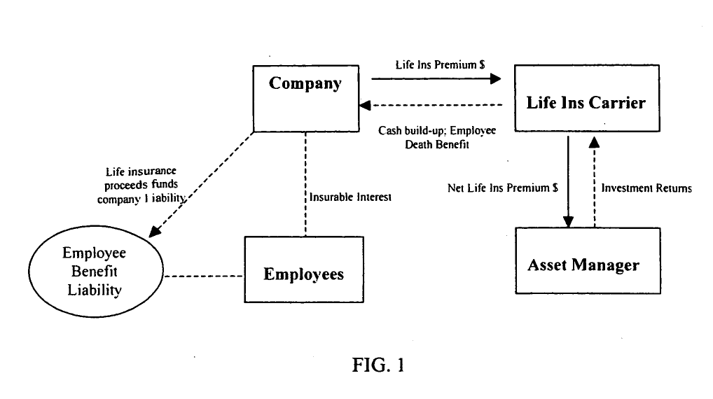

COLI policies are whole life or variable life insurance contracts purchased by companies such as banks and corporations on a pool of their employees. FIG. 1 illustrates the relationships between the various parties for a typical COLI. Since the corporation is the beneficiary of the employee death benefit as well as the cash surrender value, corporations use COLI to hedge and/or provide informal funding for their employee benefit plans. COLI policies are attractive vehicles to hedge or provide such informal funding of liabilities because receipt of death benefits is tax-free and income build-up is not taxed assuming the policy is held until the death of the insured population (the premium, however, is not tax deductible). The employees benefit indirectly from the policies by virtue of the fact that the policies provide companies an efficient means of. hedging and/or providing informal funding for their benefit plans.

COLI policies are long-term contracts, which employers typically hold until death of the insured employee, since early surrender would cause the cash build-up within the policy to become taxable as ordinary income, and in cases where the policy is a modified endowment contract with a 10% additional tax.

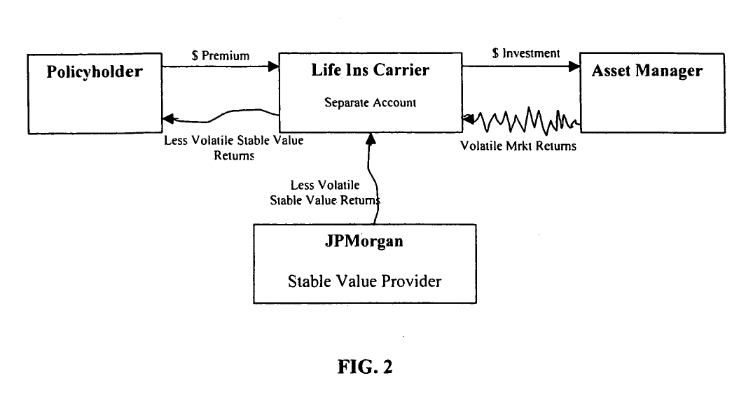

Stable Value For reasons that are explained below, there are advantages to associating a stable value contract with the COLI, as illustrated in FIG. 2.

Generally accepted accounting principles call for an owner of such a policy to report the cash surrender value of the policy on its balance sheet. The change in cash surrender value of the COLI policy is booked through the income statement. Depending on how the assets within the policy are invested, COLI returns can be volatile. Such volatility is generally deemed unattractive, especially in cases where the asset returns do not offset/hedge corresponding liabilities. A common example is an employer that has guaranteed a fixed rate of return in a deferred compensation plan and does not have fixed asset returns to offset the liability.

Two general forms of COLI are in evidence. In the first, death benefit payments are made entirely from the insurance company's general account and in the second, death benefit payments are made in part from a separate insurance company account established to fund the policies of a specific policyholder. The principal reason for establishing a separate account is to ensure that the cash surrender value of the policy is substantially protected from creditors of the insurance company.

In the case of policies supported by a carrier's general account, the cash surrender value grows at a relatively stable crediting rate that typically changes only once each year. However, when COLI is supported by an insurance company separate account, the change in cash surrender value for any reporting period is effectively the change in market value of the securities owned by the separate account. Because the policyholder reports such changes in cash surrender value in its income statement, the policyholder is effectively exposed to fluctuations in market value of securities in the separate account.

In order to mitigate the mark-to-market volatility associated with separate account life insurance policies, insurance companies may enter into derivative contracts known as “stable value contracts.” These derivative contracts allow fluctuations in separate account value to be greatly reduced and, as a result, the policyholder is able to report much more stable cash surrender values over time. A stable value rider or contract thus allows the policyholder to record less volatile COLI returns through its income statement and record the “book value” as the cash surrender value. The contract dampens volatility by deferring and amortizing market value gains and losses into the cash surrender value of the policy. Specifically, as the market value of the assets change, those changes are accreted into the cash surrender value of the policy by application of a calculated crediting rate that is periodically reset, such as monthly or quarterly.

Typically, insurers enter into stable value contracts with third party providers to enable the insurer to provide stable value riders to their policyholders. JP Morgan is a third party provider of stable value contracts to insurance companies.

Enhanced Stable Value

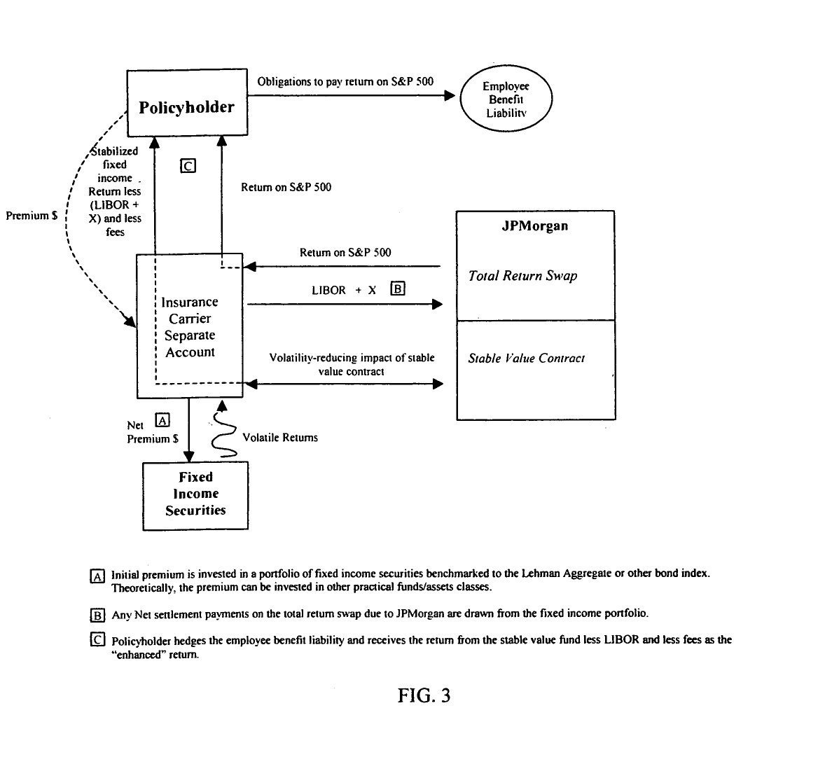

In one embodiment of the invention, the stable value provider enters into an index swap (or its economic equivalent) with the insurance company (or a separate account of the carrier) in addition to the stable value contract. The index swap adds an economic component that is not “stabilized,” so the policyholder would record changes in value in this component through its income statement. FIG. 3 illustrates this embodiment, using the example of an equity swap in which the separate account receives the total return of the S&P 500 and pays a coupon linked to LIBOR.

Using the above example, the separate account would receive the total return of the S&P 500. The separate account would also receive the return of the stabilized fixed income portfolio and pay out LIBOR+X together with applicable fees. In LIBOR+X, X is generally a percentage or spread and can be positive or negative.

This total return of all parts of the transaction is intended to equal or exceed the return earned on specialized equity funds, called “alpha-capture” or “enhanced index” funds whose purpose is to capture opportunities in the fixed income markets and add them to total returns in the equity markets. For this reason, this product might be referred to as “alpha-capture” COLI.

As cash gains or losses are incurred on the equity position, cash is added to or taken from the fixed income portfolio. The swap position is adjusted to equal the net size of the equity position.

As an example, the total return swap is settled periodically, such as monthly or quarterly. At each settlement, the stable value provider is obligated to pay the total return of the equity index to the separate account and is entitled to receive LIBOR+X from the separate account. If the equity index total return for the period exceeds the LIBOR+X return, the stable value provider makes a payment of the net difference to the separate account and the notional value of the total return swap may be increased by an amount linked to the payment from the stable value provider. The cash received by the separate account is then invested in the fixed income portfolio.

If instead, the equity index total return for the period is less than the LIBOR+X return, the separate account makes a payment of the net difference to the stable value provider and the notional value of the total return swap may be decreased by an amount linked to the payment made to the stable value provider. The cash required to make the payment to the stable value provider is generated by selling assets of the fixed income portfolio.

As interest rates change, the economics of the transaction will change for the policyholder. If interest rates generally trend upward, it is likely that the positive carry for the policyholder indicated above will drop, possibly even turning negative for a period of time. Thus, the policyholder will accept an element of yield curve risk in exchange for positive carry at the outset of the transaction.

Positive carry is the amount by which the return of the fixed income portfolio exceeds LIBOR+X. If short rates (as represented by LIBOR) trend upward, relative to the yield of the fixed income portfolio, the positive carry would decline. For example, LIBOR+X might initially be 2% and portfolio yield at the same time might be 5%. If LIBOR+X increases to 4% and the portfolio yield increases to 5.25%, the positive carry has declined from 3% to 1.25%. It is also possible that LIBOR might rise above the portfolio yield, in which case there would be negative carry. The yield curve is said to be “inverted” when short rates are higher than long rates.

One application of this product is for policyholders that have deferred employee compensation strategies linked, as in the example, to the S&P 500 Index. From the policyholder's perspective, the deferred compensation liability is marked to market, creating a short exposure to the Index. The Enhanced Stable Value product will generate an offsetting long equity position via the swap for reporting purposes, and at least at the outset of the transaction will generate significant extra return.

As noted above, the equity swap can also be replicated with equity futures. Other derivatives can be used, including swaps or futures on the Lehman Brothers U.S. Aggregate Index, the Lehman Brothers Fixed Rate MBS Index, the NASDAQ, and others. Thus, in another embodiment, the invention is extended to include other derivative type transactions, such as other equity indices or bond indices. In another embodiment, the invention achieves the same economic position as the swap with futures or other derivative instruments.

In one embodiment, the stable value provider and the equity derivative provider are the same entity, but in other embodiments, they are different entities.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

We claim:

1. A method for coordinated investment, the method comprising:
providing a stabilized return on holdings of fluctuating return assets that are held by an insurance carrier account;
providing a second return, where the second return is substantially based on value of an established index and value of a notional investment; and
adjusting the holdings of fluctuating return assets in response to a change in the second return.

2. A method according to claim 1, further comprising receiving LIBOR plus a percentage.

3. A method according to claim 2, wherein the percentage is a spread.

4. A method according to claim 2, wherein receiving LIBOR plus a percentage is linked to providing the second return.

5. A method according to claim 1, further comprising receiving LIBOR minus a percentage.

6. A method according to claim 5, wherein the percentage is a spread.

7. A method according to claim 5, wherein receiving LIBOR minus a percentage is linked to providing the second return.

8. A method according to claim 1, further comprising receiving a fee linked to providing the stabilized return.

9. A method according to claim 1, wherein the insurance carrier account is a separate account.

10. A method according to claim 1, wherein the second return is a total return swap on the established index, and based on the notional investment.

11. A method according to claim 1, wherein the second return is a futures contract on the established index, and based on the notional investment.

12. A method according to claim 1, wherein the second return is a forward contract on the established index, and based on the notional investment.

13. A method according to claim 1, wherein adjusting the holdings of fluctuating return assets occurs on a periodic basis.

14. A method according to claim 13, wherein the periodic basis is substantially every month.

15. A method according to claim 13, wherein the periodic basis is substantially every quarter.

16. A method according to claim 1, further comprising adjusting the holdings of fluctuating return assets in response to a change in the notional investment.

17. A method according to claim 1, wherein a stable value provider provides the stabilized return.

18. A method according to claim 1, wherein a stable value provider provides the second return.

19. A method according to claim 1, wherein an insurance carrier holding the insurance carrier account adjusts the holdings of fluctuating return assets.

20. A method for a stable value provider to provide coordinated investment, the method comprising:
providing a stabilized return to an insurance carrier separate account on holdings of fluctuating return assets that are held by the insurance carrier separate account;
providing a total return to the insurance carrier separate account, where the total return is based on value of an established index and value of a notional investment; and
periodically adjusting the stabilized return or the total return.

21. A method according to claim 20, wherein periodically adjusting the stabilized return occurs in response to a change in the holdings of the fluctuating return assets that are held by the insurance carrier separate account.

22. A method according to claim 20, wherein periodically adjusting the total return occurs in response to a change in the notional investment.

23. A method according to claim 20, wherein periodically adjusting the stabilized return occurs in response to a change in the notional investment.

24. A method for coordinated investment by an insurance company account, the method comprising:
receiving a stabilized return on holdings of fluctuating return assets that are held by the insurance carrier account;
receiving a second return, where the second return is substantially based on value of an established index and value of a notional investment; and
adjusting the holdings of fluctuating return assets in response to a change in the second return.

25. A method according to claim 24, further comprising providing LIBOR plus a percentage.

26. A method according to claim 25, wherein the percentage is a spread.

27. A method according to claim 25, wherein providing LIBOR plus a percentage is linked to receiving the second return.

28. A method according to claim 24, further comprising providing LIBOR minus a percentage.

29. A method according to claim 28, wherein the percentage is a spread.

30. A method according to claim 28, wherein providing LIBOR minus a percentage is linked to receiving the second return.

31. A method according to claim 24, further comprising providing a fee linked to receiving the stabilized return.

32. A method according to claim 24, wherein the insurance carrier account is a separate account.

33. A method according to claim 24, wherein the second return is a total return swap on the established index and based on the notional investment.

34. A method according to claim 24, wherein the second return is a future contract on the established index, and based on the notional investment.

35. A method according to claim 24, wherein the second return is a forward contract on the established index, and based on the notional investment.

36. A method according to claim 24, wherein adjusting the holdings of fluctuating return assets occurs on a periodic basis.

37. A method according to claim 34, wherein the periodic basis is substantially every month.

38. A method according to claim 34, wherein the periodic basis is substantially every quarter.

39. A method according to claim 24, further comprising adjusting the holdings of fluctuating return assets in response to a change in the notional investment.

40. A method according to claim 24, wherein a stable value provider provides the stabilized return.

41. A method according to claim 24, wherein a stable value provider provides the second return.

42. A method for coordinated investment by an insurance company separate account, the method comprising:
receiving a stabilized return on holdings of fluctuating return assets that are held by the separate account;
receiving a total return that is based on value of an established index and value of a notional investment; and
periodically adjusting the stabilized return or the total return.

43. A method according to claim 42, wherein periodically adjusting the stabilized return occurs in response to a change in the holdings of the fluctuating return assets that are held by the insurance carrier separate account.

44. A method according to claim 42, wherein periodically adjusting the total return occurs in response to a change in the notional investment.

45. A method according to claim 42, wherein periodically adjusting the stabilized return occurs in response to a change in the notional investment.

46. A system for coordinated investment, the system comprising:
means for providing a stabilized return on holdings of fluctuating return assets that are held by an insurance carrier account;
means for providing a second return, where the second return is substantially based on value of an established index and value of a notional investment; and
means for adjusting the holdings of fluctuating return assets in response to a change in the second return.

47. A system for a stable value provider to provide coordinated investment, the system comprising:
means for providing a stabilized return to an insurance carrier separate account on holdings of fluctuating return assets that are held by the insurance carrier separate account;
means for providing a total return to the insurance carrier separate account, where the total return is based on value of an established index and value of a notional investment; and
means for periodically adjusting the stabilized return or the total return.

48. A system for coordinated investment by an insurance company account, the system comprising:
means for receiving a stabilized return on holdings of fluctuating return assets that are held by the insurance carrier account;
means for receiving a second return, where the second return is substantially based on value of an established index and value of a notional investment; and
means for adjusting the holdings of fluctuating return assets in response to a change in the second return.

49. A system for coordinated investment by an insurance company separate account, the system comprising:
means for receiving a stabilized return on holdings of fluctuating return assets that are held by the separate account;
means for receiving a total return that is based on value of an established index and value of a notional investment; and
means for periodically adjusting the stabilized return or the total return.

50. Computer executable software code transmitted as an information signal, the code for coordinated investment, the code comprising:
code to provide a stabilized return on holdings of fluctuating return assets that are held by an insurance carrier account;
code to provide a second return, where the second return is substantially based on value of an established index and value of a notional investment; and
code to adjust the holdings of fluctuating return assets in response to a change in the second return.

51. Computer executable software code transmitted as an information signal, the code for a stable value provider to provide coordinated investment, the code comprising:
code to provide a stabilized return to an insurance carrier separate account on holdings of fluctuating return assets that are held by the insurance carrier separate account;
code to provide a total return to the insurance carrier separate account, where the total return is based on value of an established index and value of a notional investment; and
code to periodically adjust the stabilized return or the total return.

52. Computer executable software code transmitted as an information signal, the code for coordinated investment by an insurance company account, the code comprising:
code to receive a stabilized return on holdings of fluctuating return assets that are held by the insurance carrier account;
code to receive a second return, where the second return is substantially based on value of an established index and value of a notional investment; and
code to adjust the holdings of fluctuating return assets in response to a change in the second return.

53. Computer executable software code transmitted as an information signal, the code for coordinated investment by an insurance company separate account, the code comprising:
code to receive a stabilized return on holdings of fluctuating return assets that are held by the separate account;
code to receive a total return that is based on value of an established index and value of a notional investment; and
code to periodically adjust the stabilized return or the total return.

54. A computer-readable medium having computer executable software code stored thereon, the code for coordinated investment, the code comprising:
code to provide a stabilized return on holdings of fluctuating return assets that are held by an insurance carrier account;
code to provide a second return, where the second return is substantially based on value of an established index and value of a notional investment; and
code to adjust the holdings of fluctuating return assets in response to a change in the second return.

55. A computer-readable medium having computer executable software code stored thereon, the code for a stable value provider to provide coordinated investment, the code comprising:
code to provide a stabilized return to an insurance carrier separate account on holdings of fluctuating return assets that are held by the insurance carrier separate account;
code to provide a total return to the insurance carrier separate account, where the total return is based on value of an established index and value of a notional investment; and
code to periodically adjust the stabilized return or the total return.

56. A computer-readable medium having computer executable software code stored thereon, the code for coordinated investment by an insurance company account, the code comprising:
code to receive a stabilized return on holdings of fluctuating return assets that are held by the insurance carrier account;
code to receive a second return, where the second return is substantially based on value of an established index and value of a notional investment; and
code to adjust the holdings of fluctuating return assets in response to a change in the second return.

57. A computer-readable medium having computer executable software code stored thereon, the code for coordinated investment by an insurance company separate account, the code comprising:
code to receive a stabilized return on holdings of fluctuating return assets that are held by the separate account;
code to receive a total return that is based on value of an established index and value of a notional investment; and
code to periodically adjust the stabilized return or the total return.

58. A programmed computer for coordinated investment, comprising:
a memory having at least one region for storing computer executable program code; and
a processor for executing the program code stored in the memory; wherein the program code comprises:
code to provide a stabilized return on holdings of fluctuating return assets that are held by an insurance carrier account;
code to provide a second return, where the second return is substantially based on value of an established index and value of a notional investment; and
code to adjust the holdings of fluctuating return assets in response to a change in the second return.

59. A programmed computer for a stable value provider to provide coordinated investment, comprising:
a memory having at least one region for storing computer executable program code; and
a processor for executing the program code stored in the memory; wherein the program code comprises:
code to provide a stabilized return to an insurance carrier separate account on holdings of fluctuating return assets that are held by the insurance carrier separate account;
code to provide a total return to the insurance carrier separate account, where the total return is based on value of an established index and value of a notional investment; and
code to periodically adjust the stabilized return or the total return.

60. A programmed computer for coordinated investment by an insurance company account, comprising:
a memory having at least one region for storing computer executable program code; and
a processor for executing the program code stored in the memory; wherein the program code comprises:
code to receive a stabilized return on holdings of fluctuating return assets that are held by the insurance carrier account;
code to receive a second return, where the second return is substantially based on value of an established index and value of a notional investment; and
code to adjust the holdings of fluctuating return assets in response to a change in the second return.

61. A programmed computer for coordinated investment by an insurance company separate account, comprising:
a memory having at least one region for storing computer executable program code; and
a processor for executing the program code stored in the memory; wherein the program code comprises:
code to receive a stabilized return on holdings of fluctuating return assets that are held by the separate account;
code to receive a total return that is based on value of an established index and value of a notional investment; and
code to periodically adjust the stabilized return or the total return.
